(19) United States
(12) Patent Application Publication
(10) Pub. No.: US 2007/0101156 A1
(43) Pub. Date: May 3, 2007

(54) Methods and systems for associating an embedded security chip with a computer

(76) Inventors: Manuel Novoa, Cypress, TX (US); Valiuddin Y. Ali, Houston, TX (US); Lan Wang, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/264,782

(22) Filed: Oct. 31, 2005

(51) Int. Cl. G06F 12/14

(52) U.S. Cl. 713/190

(57) ABSTRACT

In at least some embodiments, a method comprises initializing an embedded security chip for use with a computer and performing a binding operation between the embedded security chip and the computer. The method further comprises, during each subsequent boot of the computer, validating the binding operation before the embedded security chip performs a cryptographic function.

### BACKGROUND

Computers and computer networks have provided individuals and enterprises with numerous capabilities and conveniences. For example, electronic data transmissions between individuals and/or enterprises are part of the daily operations of many businesses and organizations. Many security techniques such as passwords, cryptography, digital certificates and “firewalls” are used to protect data stored on computers and computer networks. Unfortunately, software-only security techniques have been vulnerable to the malicious efforts of hackers.

To improve the security of data stored on computers and computer networks, hardware-based security techniques have been formulated. One hardware-based security technique implements an embedded security chip (e.g., a Trusted Platform Module (TPM)) that stores secrets such as encryption keys and/or hash values and performs internal cryptographic operations using these secrets. Thus, the secrets are not available outside the embedded security chip.

To guard against physically tampering with an embedded security chip and retrieving the protected secrets, each embedded security chip needs to be “bound” to a single computer. For example, efforts to bind an embedded security chip to a single computer have included using tamper resistant tape to visually detect tampering, soldering the embedded security chip to a computer unit's processor board (e.g., motherboard) or using a chassis lock. Unfortunately, these efforts do not guarantee that an embedded security chip will not be physically tampered with. In other words, a malicious hacker may still be able to physically access the computer, remove the embedded security chip and retrieve the secrets. The secrets may be used to access sensitive data.

### BRIEF DESCRIPTION OF THE DRAWINGS

For a detailed description of exemplary embodiments of the invention, reference will now be made to the accompanying drawings in which:

FIG. 1 shows a system in accordance with embodiments of the invention;

FIG. 2 shows a diagram that illustrates a validation process in accordance with embodiments of the invention;

FIG. 3 shows another diagram that illustrates a validation process in accordance with embodiments of the invention;

FIG. 4 shows a method in accordance with embodiments of the invention; and

FIG. 5 shows another method in accordance with alternative embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the invention are directed to systems and methods that protect secrets stored by an embedded security chip such as a Trusted Platform Module (TPM) even if the embedded security chip is disconnected from its computer platform or is otherwise tampered with. In at least some embodiments, if an embedded security chip is successfully initialized for use with a computer, a data-structure that identifies the unique relationship between the embedded security chip and the computer is generated. During each subsequent boot of the computer, a verification process is performed to validate the identities of the computer and the embedded security chip based on the data-structure. In some embodiments, the verification process involves a cryptographic binding between the embedded security chip and the platform. If the identities of both the embedded security chip and the platform are validated, the embedded security chip is operable to perform cryptographic functions such as encrypting/decrypting data for the platform. If the identity of either the embedded security chip or the platform is not validated, one or more actions are performed to prevent unauthorized access and/or use of the secrets stored by the embedded security chip.

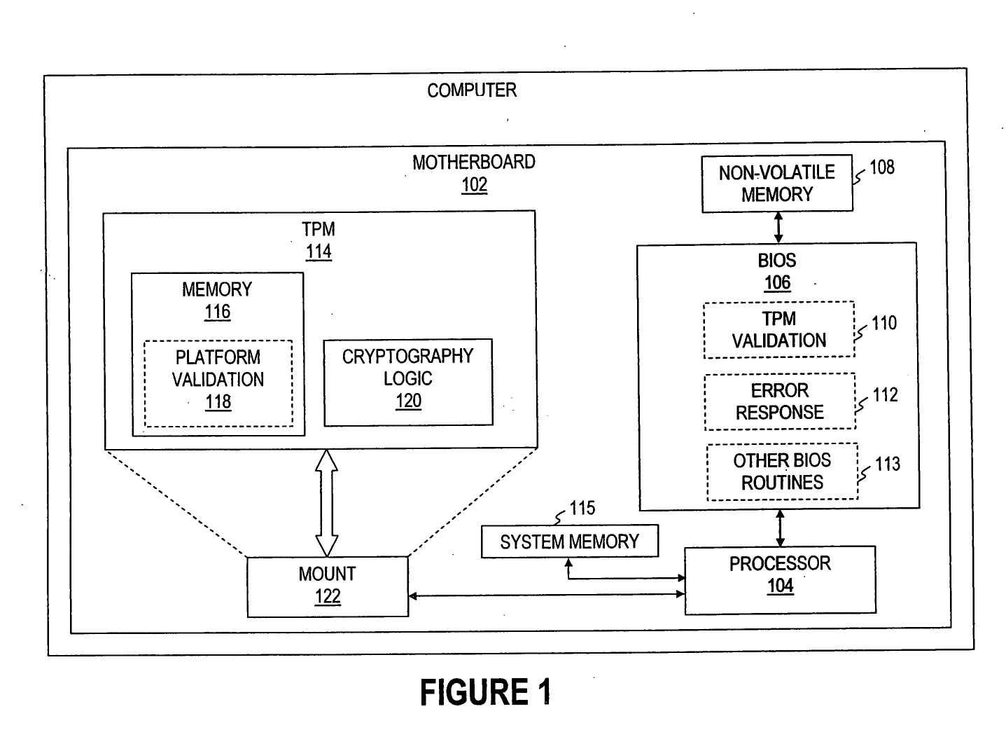

FIG. 1 shows a computer system 100 in accordance with embodiments of the invention. As shown in FIG. 1, the computer system 100 comprises a motherboard 102 configured to have various electronic components attached thereto. In at least some embodiments, the system 100 comprises a processor 104 that couples to a Basic Input/Output System (BIOS) 106 and a system memory 115. The BIOS 106 may be associated with a BIOS chip. The processor 104 also couples to a mount 122 of the motherboard 102, which enables a Trusted Platform Module (TPM) 114 to be detachably or fixedly connected to the motherboard 102.

As shown, the TPM 114 comprises a memory 116 that stores platform validation instructions 118. The TPM 114 also comprises cryptographic logic 120 that is configured to provide cryptographic functions such as asymmetric key functions, secure storage of hash values, endorsement key (EK) functions, initialization functions, and management functions.

As shown, the BIOS 106 comprises TPM validation instructions 110 and error response instructions 112. The BIOS 106 also comprises other BIOS routines 113 that enable other known or future BIOS processes to be performed. In some embodiments, the BIOS instructions (e.g., the TPM validation 110, the error response instructions 112, or the other BIOS routines 113) are decompressed at run time and stored into the system memory 109. When executed, the TPM validation instructions 110 are configured to cause at least one of two processes to occur. The TPM validation instructions 110 may function in conjunction with the platform validation instructions 118 to provide a combined TPM/platform validation that is dependent on functions provided by both the TPM 114 and the BIOS 106. Both of the processes are configured to ensure that the TPM 114 is the TPM with which the computer 100 is originally initialized and also that the computer 100 is the computer with which the TPM 114 is initialized.

In the first process, the TPM 114 is instructed to generate a data-structure (i.e., a secret) that is unique. If initialization of the TPM 114 by the computer 100 is successful, the secret is stored in the TPM 114 and in a non-volatile memory 108 coupled to or internal to the BIOS 106. In at least some embodiments, the non-volatile memory 108 is only accessible to the BIOS 106 and is lockable upon exiting a power-on self test (POST) or before the computer 100 finishes booting. For example, the non-volatile memory 108 may be lockable using a password-controlled procedure. The secret stored by the non-volatile memory 108 is unique in both time and space (i.e., the secret is a random number that should not ever be repeatable or computable). The secret may be, for example, a pass phrase, a password, a Universally Unique Identifier (UUID) or any other secret. In some embodiments, the secret is obtained using a challenge/response protocol similar to operating system (OS) login schemes. For example, a protocol such as a Zero Knowledge Proof (ZKP) may be implemented. In embodiments that implement ZKP, the non-volatile memory 108 does not need to store the secret.

In at least some embodiments, the secret may be obfuscated using the TPM 114. For example, the TPM 114 (or some other entity) may generate a random number (e.g., a binary large object or “BLOB”) as the secret. The secret is then associated uniquely with the TPM 114 via a TPM “BIND” or “SEAL” command. In some embodiments, the bound/sealed secret and/or a hash of the secret is stored within the non-volatile memory 108 associated with the BIOS 106. The hash is generated by a security hash algorithm such as “SHA-1” or “SHA-256.”

Upon subsequent boot of the computer 100, the BIOS chip 106 unseals the secret. The unsealed secret is re-hashed using the same security hashing algorithms described above. This re-hashed value is then compared to the hashed value previously stored in the non-volatile memory 108. If the hashes match, then the identify of the TPM 114 is verified since only the TPM 114 could have unsealed the correct value (per the properties of a TPM as defined by the Trusted Computing Group).

In at least some embodiments, new TPM initialization commands or binding commands are implemented such that the TPM 114 will not initialize itself unless proper authentication credentials (e.g., validation of the secret) are provided by the computer 100 to the TPM 114. For example, the new TPM commands could be implemented as a derivative of some existing TPM commands like “TPM Init” and enable the BIOS 106 to pass in the hashed value of the unsealed secret (or some other unique platform-specific secret) to the TPM 114. The TPM 114 can then verify if the passed in secret matches the secret previously stored in the memory 116. If the secrets match, the TPM 114 returns a success notification to the BIOS 106 and continues to behave normally, enabling the computer 100 to boot. During the computer's normal boot process, the TPM 114 may use the secret as part of the TPM initialization process performed by the BIOS 106. For example, in some embodiments, the secret is used as a symmetric encryption key that increases the security of a challenge/response protocol between the BIOS 106 and the TPM 114.

If the value of the passed in secret does not match the value previously stored in the memory 116 (or if a secret is not provided), the TPM 114 is configurable to refuse initialization and/or to clear all protected secrets (i.e., return to a TPM factory reset state) based on policies that are controlled by the TPM owner or an authorized user. The TPM 114 also may return an error notification to the BIOS. In at least some embodiments, the BIOS is able to track startup sequences in which the TPM/platform validation failed.

In response to an error notification, the error response instructions 112 stored by the BIOS chip 106 are executed. The error response instructions 112 are configured to cause at least one action such as halting the computer's boot process, notifying a user or system administrator, booting with the TPM 114 disabled or clearing all the secrets protected by the TPM 114. The actions performed by the BIOS 106 in response to an error notification may be in addition to any actions automatically performed by the TPM 114. Also, all error notifications to the BIOS and subsequent responses may be logged for future auditing.

In at least some embodiments, the TPM 114 is configured to perform some operations for the computer 100 without being “owned” by the computer 100. For example, there may be cases where a portion of the TPM 114 performs non-critical operations. In such a case, the TPM 114 is allowed to initialize after a TPM/platform validation failure. However, no critical TPM operation (i.e., no operation involving the secrets protected by the TPM) is allowed.

As previously mentioned, the TPM validation instructions 110 may cause a second process to be performed. In the second process, a measurement that is unique to the computer 100 is dynamically generated by the BIOS every time the computer 100 is powered on from a low-power state (i.e., at each resume from a S4/S5 state). The unique measurement is based on a plurality of configuration parameters for the computer 100. For example, these configuration parameters could include, but are not limited to, some combinations of the platform's unique identifier (UUID), a serial number, asset tags, a hard drive identifier (ID), a list of peripheral component interconnect (PCI) devices present in the computer 100, and TPM Platform Configuration Register (PCR) values. Thus, if any of the computer configurations included in the measurement changes, the final measurement will change. If none of the computer configurations included in the measurement change, the final measurement remains the same. In at least some embodiments, the computer's manufacturer dictates the computer-specific configuration parameters that are included in the measurement with the condition that the measurement is unique to the computer 100.

During the first boot of the computer 100 (or during a user/administrator designated registration boot cycle), the BIOS generates the unique measurement of the computer 100. The unique measurement is passed as a parameter to the TPM 114 using a command from the BIOS to the TPM 114. In at least some embodiments, the standard TPM initialization commands and/or startup commands are extended to enable the TPM 114 to receive the unique measurement as a parameter.

If an Endorsement Key (EK) has been established with the TPM 114 (i.e., if ownership of the TPM 114 has been established), the TPM 114 securely stores the measurement. If an EK has not been established with the TPM 114, then the TPM 114 ignores (or otherwise discounts) the measurement received from the BIOS. After the measurement is stored in the TPM 114, the TPM 114 does not allow any changes to the stored measurement unless the EK has been changed (i.e., commands such as TPM_OwnerClear or TPM_ForceClear should not affect the stored measurement).

Upon every subsequent boot after the initial measurement is stored, the BIOS will again measure the unique platform configurations, generate a measurement and send the new measurement to the TPM 114 (e.g., using an extended TPM initialization command “TPM_INIT” or extended TPM startup command “TPM_STARTUP”). If the incoming measurement does not match the stored measurement, the TPM 114 is configurable to cease receiving (or performing) commands from the BIOS or the TPM software stack (TSS). Additionally or alternatively, the TPM 114 may clear its internal state to remove all protected secrets.

In at least some embodiments, the TPM 114 also sends an error notification to the BIOS to indicate a validation failure (i.e., the measurement that identifies the current system does not match the stored measurement that identifies the TPM's owner). In response to receiving the error notification, the BIOS causes the error response instructions 112 to be executed. As previously described, the error response instructions 112 are configured to cause at least one action such as halting the computer's boot process, notifying a user or system administrator, booting with the TPM 114 disabled or clearing all the secrets protected by the TPM 114. Also, all error notifications to the BIOS and subsequent responses may be logged for future auditing. In at least some embodiments, the TPM owner or an authorized user is able to selectively control which error responses are used.

In contrast to the first process previously described, the second process does not use the non-volatile memory 108 to store the sealed and/or hashed secret. Thus, in embodiments that implement the second process, the non-volatile memory 108 may be eliminated to lower cost.

By implementing either the first process, the second process or a combination of the processes previously described, it is possible to detect whether an embedded security chip such as a TPM has been physically tampered with (e.g., by removing the embedded security chip from one computer for use in another computer). In at least some embodiments, the embedded security chip is pluggable rather than soldered to a motherboard. In such embodiments, a computer manufacturer is able to implement a single motherboard that is capable of supporting an embedded security chip regardless of whether consumers purchase an embedded security chip (i.e., the motherboard 102 comprises a corresponding mount 122 regardless of whether an embedded security chip is installed or not). If a consumer decides to purchase an embedded security chip after the initial computer purchase, a pluggable embedded security chip may be installed by the consumer, a vendor or the manufacturer with relative ease (compared to soldering). Although some embodiments implement pluggable embedded security chips as described above, alternative embodiments implement embedded security chips that are soldered to the motherboard 102. In such embodiments, soldering increases the difficulty of removing the embedded security chip from its intended platform.

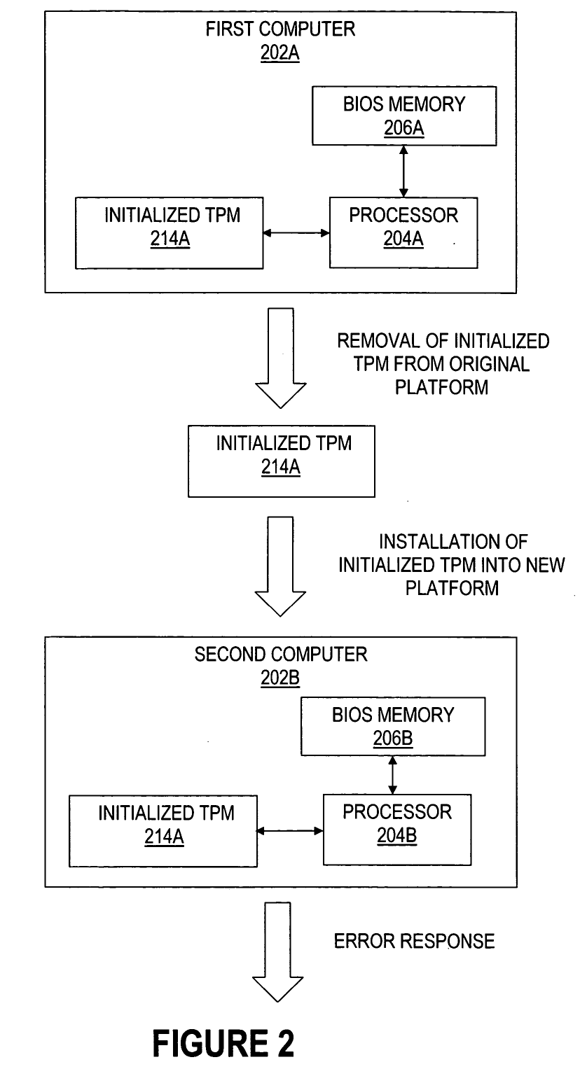

FIG. 2 shows a diagram 200 that illustrates a validation process in accordance with embodiments of the invention. As shown, a first computer 202A comprises an initialized TPM 214A (i.e., the TPM 214A has been initialized to protect secrets such as cryptographic keys exclusively for the first computer 202A) that couples to a BIOS memory 206A via a processor 204A. The processor 204A is configured to process instructions and data received from the BIOS memory 206A and to enable communication between the initialized TPM 214A and the BIOS memory 206A. In embodiments that implement the first process described above, the initialization process causes the BIOS memory 206A to store a sealed secret as well as a hashing of the secret generated by the initialized TPM 214A. Alternatively, in embodiments that implement the second process described above, the initialization process causes the initialized TPM 214A to store a unique measurement received from the BIOS of the first computer 202A. The unique measurement is based on the first computer's unique configuration parameters. During every boot of the first computer 202A, either of the first or second processes previously described is implemented to validate the TPM/platform.

As shown in FIG. 2, removal of the initialized TPM 214A from the original platform (the first computer 202A) may occur. For example, if the initialized TPM 214A is pluggable, a hacker may simply access and unplug the initialized TPM 214A. Alternatively, if the initialized TPM 214A is soldered, a hacker may access and carefully remove the initialized TPM 214A.

As shown in FIG. 2, installation of the initialized TPM 214A into a different platform may occur (e.g., by soldering or plugging the initialized TPM 214A into a corresponding socket or mount). However, when the second computer 202B boots with the initialized TPM 214A, the TPM/platform validation fails. For example, if the first validation process described above is implemented, the TPM/platform validation fails because the BIOS memory 206B of the second computer 202B does not have the secret to be sent to the TPM 214A for validation. If the second validation process described above is implemented, the TPM/platform validation fails because the unique measurement needed for validation cannot be provided by the second computer's BIOS to the initialized TPM 214A (or the measurement provided does not match the measurement stored in the initialized TPM 214A). If both validation processes are implemented, the TPM/platform validation fails because one (or both) of the secret and the unique measurement are not validated. After a validation failure, at least one error response occurs such as halting the boot process, notifying a user or system administrator, booting with the initialized TPM 214A disabled or clearing all the secrets protected by the initialized TPM 214A. Again, the error responses are selectable by a TPM owner or an authorized user based on preferences.

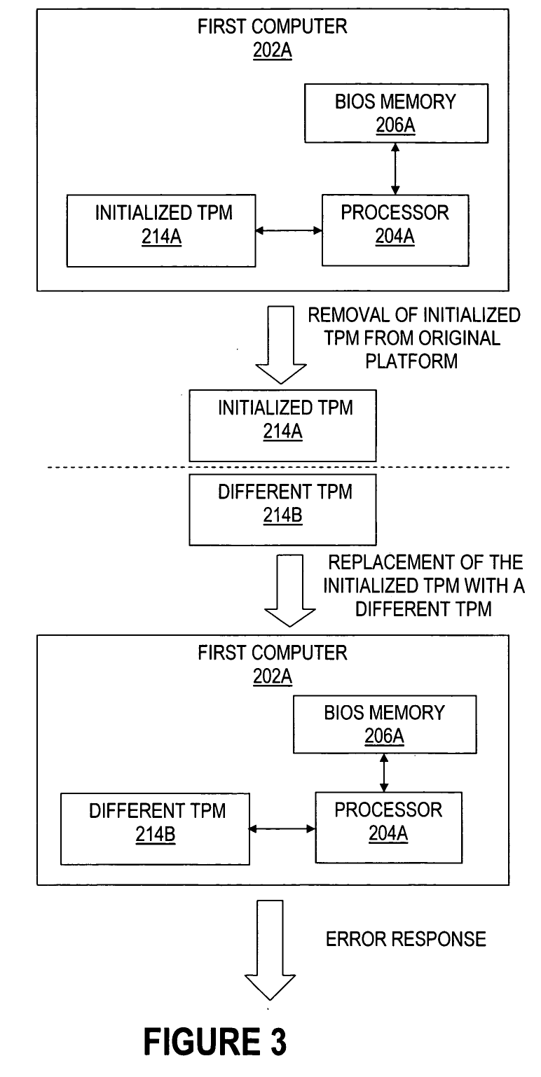

FIG. 3 shows another diagram 300 that illustrates a validation process in accordance with embodiments of the invention. As previously described for FIG. 2, the first computer 202A comprises an initialized TPM 214A that couples to a BIOS memory 206A via a processor 204A. Again, the processor 204A enables communication between the initialized TPM 214A and the BIOS memory 206A as well as processing of instructions and data. During the initialization process of the TPM, either the BIOS memory 206A receives and stores a sealed secret and a hashing of the secret received from the initialized TPM 214A or the initialized TPM 214A receives and stores a measurement that is unique to the first computer 202A.

As shown, removal of the initialized TPM 214A from the first computer 202A and replacement of the initialized TPM 214A with a different TPM 214B may occur. The different TPM 214B may be new, previously initialized on another platform, or previously reset to a factory state. The removal and installation may involve pluggable TPMs or soldered TPMs. When the first computer 202A boots with the different TPM 214B, the TPM/platform validation fails. For example, if the first validation process described above is implemented, the TPM/platform validation fails because the different TPM 214B is unable to unseal the sealed secret and/or does not provide a correct hashing of the secret for comparison with the hashed secret stored in the BIOS memory 206A. If the second validation process described above is implemented, the TPM/platform validation fails because the different TPM 214B does not store the unique measurement that is needed for validation. As a result, an error response occurs such as halting the boot process, notifying a user or system administrator, booting with the different TPM 214B disabled or clearing any secrets protected by the different TPM 214B.

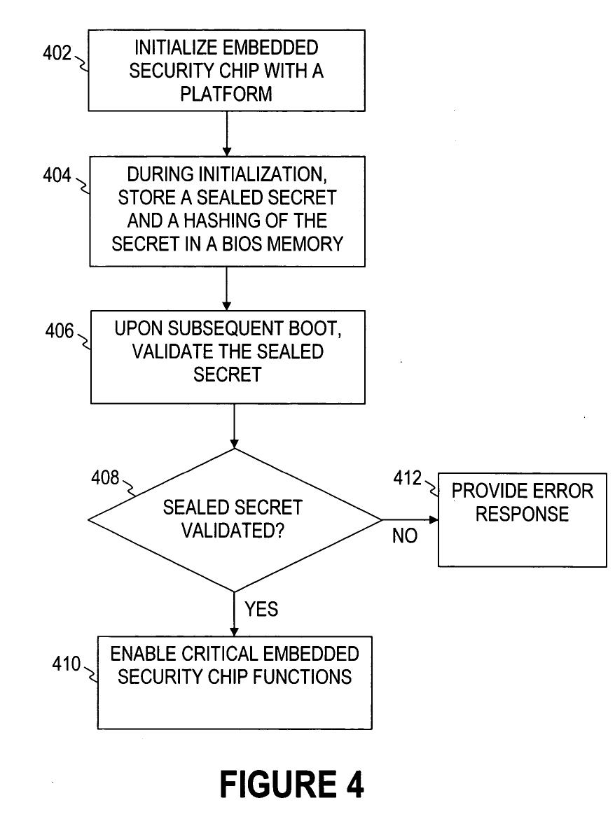

FIG. 4 shows a method 400 in accordance with embodiments of the invention. As shown in FIG. 4, the method 400 comprises initializing an embedded security chip with a computer platform (block 402). During the initialization, a sealed secret and a hashing of the secret is stored in a secure BIOS memory (block 404). In at least some embodiments, the secret is sealed and the hashing of the secret is performed by the embedded security chip. Upon subsequent boot, the sealed secret is validated (block 406). For example, in cases where the secret is sealed by the embedded security chip, the sealed secret is validated by unsealing the sealed secret using the embedded security chip and re-hashing the unsealed secret for comparison with the hashed secret stored in the BIOS memory. If the hashed values match, the secret is validated.

If the sealed secret is validated (determination block 408), critical embedded security chip functions are enabled (block 410). For example, critical embedded security chip functions such as encryption/decryption of data using cryptographic keys may be enabled. If the sealed secret is not validated (determination block 408), an error response is provided (block 412). For example, error responses such as halting a boot process, notifying a user or system administrator, booting with the embedded security chip disabled or clearing any secrets (e.g., cryptographic keys) protected by the embedded security chip may be provided.

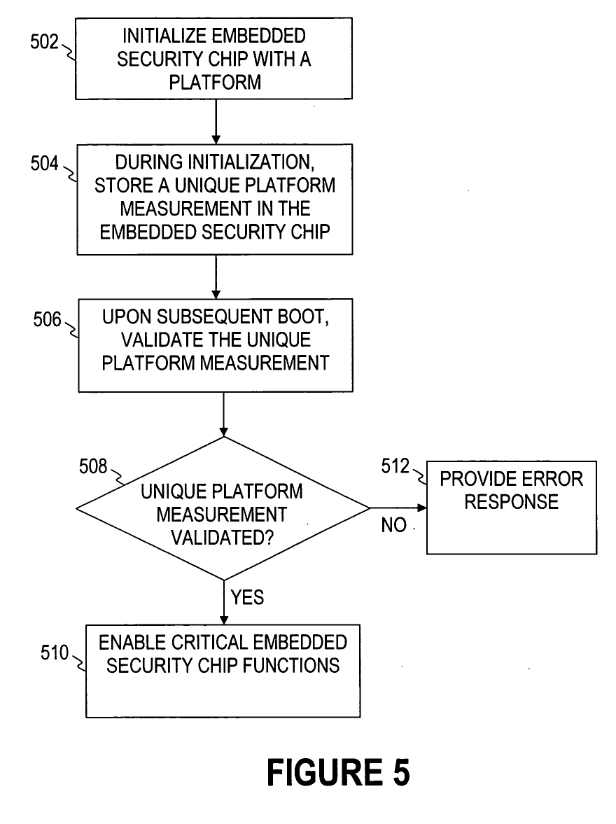

FIG. 5 shows another method 500 in accordance with alternative embodiments of the invention. As shown in FIG. 5, the method 500 comprises initializing an embedded security chip with a computer platform (block 502). During the initialization, a unique platform measurement is stored in the embedded security chip (block 504). In at least some embodiments, the unique platform measurement is generated by the BIOS based on a set of configuration parameters specific to a computer platform. For example, configuration parameters such as combinations of the platform's unique identifier (UUID), a serial number, asset tags, a hard drive identifier (ID), a list of peripheral component interconnect (PCI) devices present in the computer 100, and TPM Platform Configuration Register (PCR) values may be used. Upon subsequent boot, the unique platform measurement is validated (block 506). The unique platform measurement may be validated by comparing the measurement stored in the embedded security chip during initialization of the embedded security chip with the measurement generated by the BIOS during each subsequent boot of a computer platform.

If the unique measurement is validated (determination block 508), critical embedded security chip functions are enabled (block 510). Again, critical embedded security chip functions such as encryption/decryption of data using cryptographic keys may be enabled. If the sealed secret is not validated (determination block 508), an error response is provided (block 512). Again, error responses such as halting a boot process, notifying a user or system administrator, booting with the embedded security chip disabled or clearing any secrets (e.g., cryptographic keys) protected by the embedded security chip may be provided. In at least some embodiments, the error responses are selectable and adjustable by the TPM owner or an authorized user.

What is claimed is:

1. A method, comprising:
initializing an embedded security chip for use with a computer;
performing a binding operation between the embedded security chip and the computer; and
during each subsequent boot of the computer, validating the binding operation before the embedded security chip performs a cryptographic function.

2. The method of claim 1 wherein performing a binding operation comprises storing a secret in a secure memory of the computer, the secret having been sealed by the embedded security chip.

3. The method of claim 1 wherein performing a binding operation comprises storing a hashing of a secret in a secure memory.

4. The method of claim 3 wherein validating the binding operation comprises re-hashing the secret using the embedded security chip and comparing the re-hashing of the secret with the hashing of the secret stored in the secure memory.

5. The method of claim 1 wherein performing a binding operation comprises storing a measurement based on unique configuration parameters of the computer in the embedded security chip.

6. The method of claim 5 wherein validating the binding operation comprises comparing a current measurement based on unique configuration parameters of a computer with the measurement stored in the embedded security chip.

7. A computer system, comprising:
an embedded security chip coupled to the processor, the embedded security chip is configured to perform a cryptographic function;
a memory coupled to the embedded security chip, the memory stores validation instructions that, when executed, prevent use of the cryptographic function unless the embedded security chip is validated as having been previously initialized for use with the computer system.

8. The computer system of claim 7 wherein the embedded security chip is initialized for use with the computer system based on a binding operation that comprises transferring secret data from the embedded security chip to the computer system.

9. The computer system of claim 8 wherein the secret data is sealed by the embedded security chip.

10. The computer system of claim 8 wherein the binding operation further comprises storing a hashing of the secret data, the hashing of the secret data being performed by the embedded security chip.

11. The computer system of claim 7 wherein the embedded security chip is initialized for use with the computer system based on a binding operation that comprises the embedded security chip receiving a measurement from the computer system, the measurement being based on unique configuration parameters of the computer system.

12. The computer system of claim 7 wherein the memory stores error response instructions that, when executed, cause an action in response to a failure to validate, the action being selected from a group of actions consisting of halting a boot process, notifying an owner of the embedded security chip, booting with the embedded security chip disabled, and clearing all secrets stored by the embedded security chip.

13. The computer system of claim 7 further comprising a motherboard, wherein the embedded security chip is detachably connected to the motherboard.

14. The computer system of claim 7 further comprising a motherboard, wherein the embedded security chip is soldered to the motherboard.

15. The computer system of claim 7 wherein the embedded security chip comprises a Trusted Platform Module (TPM) and the memory comprises a BIOS memory.

16. The computer system of claim 7 wherein the embedded security chip is initialized for use with the computer system based on an extended Trusted Platform Module (TPM) initialization command that enables the computer system to pass in a secret to a TPM.

17. A storage medium having computer-readable instructions that, when executed, cause a computer to:
initialize an embedded security chip for use with the computer;
generate a secret that uniquely associates the embedded security chip with the computer; and
during each subsequent boot of the computer, verify the identities of the embedded security chip and the computer based on the secret.

18. The storage medium of claim 17 wherein the computer-readable instructions, when executed, further cause the computer to perform at least one action in response to a failure to verify the identities of the embedded security chip and the computer, the at least one action selected from a group of actions consisting of halting a boot process, notifying an owner of the embedded security chip, booting with the embedded security chip disabled, and clearing all secrets stored by the embedded security chip.

19. The storage medium of claim 17 wherein the computer-readable instructions, when executed, further cause the computer to store the secret in a secure BIOS memory of the computer.

20. The storage medium of claim 17 wherein the computer-readable instructions, when executed, further cause the computer to store the secret in the embedded security chip.

21. A computer system, comprising:
means for generating a data-structure that uniquely identifies an existing relationship between an embedded security chip and a computer; and
means for preventing access to secrets stored by the embedded security chip until the embedded security chip and the computer are positively identified using the data-structure.

22. The computer system of claim 21 further comprising means for securely storing the data-structure in the embedded security chip during an initialization of the embedded security chip.

23. The computer system of claim 21 further comprising means for securely storing the data-structure in a BIOS memory during a boot process of the computer system.
